(19) United States
(12) Patent Application Publication
(10) Pub. No.: US 2020/0107662 A1
(43) Pub. Date: Apr. 9, 2020

(54) LIGHT AND EDIBLE STRAW

(71) Applicant: ZHEN YI XUAN FOOD ENTERPRISES CO., Taichung (TW)

(72) Inventors: YI-MIN CHUANG, Taichung (TW); Chih-ching CHANG, Taichung (TW)

(21) Appl. No.: 16/590,311

(22) Filed: Oct. 1, 2019

(30) Foreign Application Priority Data
Oct. 4, 2018 (TW) 107135013

(51) Int. Cl. A47G 21/18; A23P 20/10; A23P 30/00; A23L 29/212

(52) U.S. Cl. CPC A47G 21/183; A23P 20/10; A23V 2002/00; A23L 29/212; A23P 30/00

(57) ABSTRACT

A light and edible straw includes a tube made of an edible material, microcapsules made of another edible material, and a protective film made of another edible material. The tube includes an internal face, an external face, an upper end face and a lower end face. The microcapsules are inserted in a wall of the tube. The protective film includes an internal portion covering the internal face of the tube, an external portion covering the external face of the tube, an upper annular portion covering the upper end face of the tube, and a lower annular portion covering the lower end face of the tube. Thus, the protective film keeps the tube from liquid.

### BACKGROUND OF INVENTION

### 1. Field of Invention

The present invention relates to a straw and, more particularly, to a light and edible straw.

### 2. Related Prior Art

A straw is often used for drinking from a pack. There are rectilinear straws, telescopic straws and flexible straws. A telescopic straw includes at least two sections of tubes. A flexible straw includes a bellows-shaped section.

Conventional straws are disposed of after they are used. The conventional straws are made of synthetic resin such as poly propylene (“PP”) by injection molding, extrusion, blow molding or drawing for example. Such synthetic resin cannot be decomposed. Hence, the straws that are disposed of are a serious environmental and ecological problem.

To solve this environmental and ecological problem, there have been various attempts to make straws of decomposable materials. For example, Japanese Patent No. 5393566 and Chinese Patent No. 102206402 have been issued to a straw that is made of a decomposable material.

There have been attempts to make straws of edible materials. For example, Taiwanese Patent No. M469004, an edible straw includes a tube made of starch, a layer of hydrocolloid coated on an internal face of the tube made of starch, and another layer of hydrocolloid coated on an external face of the tube made of starch. The starch is added with additives such as sugar, salt and/or milk powder to modify the flavor of the starch. The tube made of starch is dry and solid. The edible straw is not tasty since the tube made of starch is dry. The edible straw is hard and heavy since the tube made of starch includes a sloid wall. It is difficult to chew the edible straw since it is hard. It is inconvenient to carry the edible straw since it is heavy.

The present invention is therefore intended to obviate or at least alleviate the problems encountered in prior art.

### SUMMARY OF INVENTION

It is the primary objective of the present invention to provide a light and edible straw.

To achieve the foregoing objective, the light and edible straw includes a tube made of an edible material, microcapsules made of another edible material, and a protective film made of another edible material. The tube includes an internal face, an external face, an upper end face and a lower end face. The microcapsules are inserted in a wall of the tube. The protective film includes an internal portion covering the internal face of the tube, an external portion covering the external face of the tube, an upper annular portion covering the upper end face of the tube, and a lower annular portion covering the lower end face of the tube. Thus, the protective film keeps the tube from liquid.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a process for making a light and edible straw according to the preferred embodiment of the present invention;

FIG. 2 is a cross-sectional view of an empty microcapsule of the light and edible straw shown in FIG. 1;

FIG. 3 is a cross-sectional view of a filled microcapsule of the light and edible straw shown in FIG. 1;

FIG. 4 is a cross-sectional view of a light and edible straw in a shape made in the process shown in FIG. 1; and

FIG. 5 is a cross-sectional view of a light and edible straw in another shape made in the process shown in FIG. 1.

### DETAILED DESCRIPTION OF PREFERRED EMBODIMENT

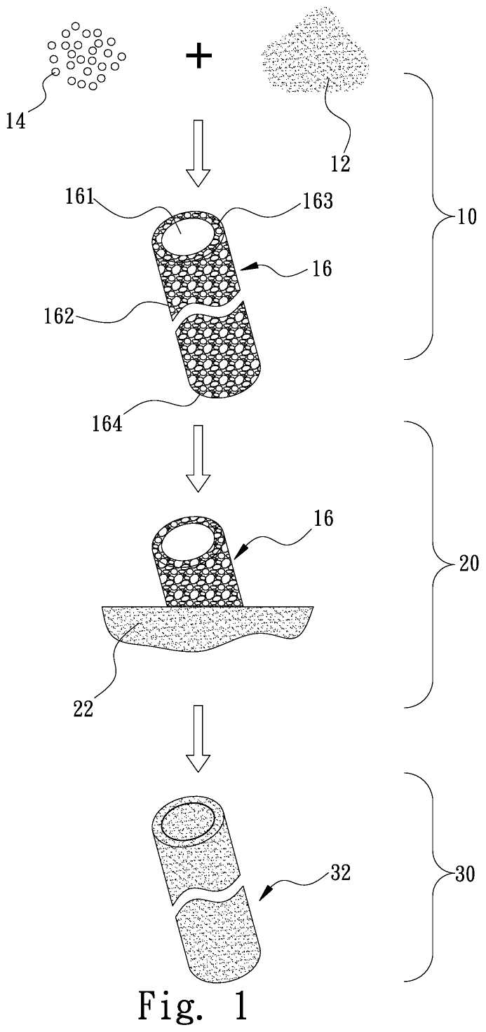

Referring to FIG. 1, a light and edible straw 32 is made in a process including mixing, soaking and finishing according to the preferred embodiment. At 10, the mixing is conducted. At a proper proportion of weight, a starch 12 is mixed with microcapsules 14 and liquid such as clean water. The mixture is shaped into a tube 16. The shaping is done by injection molding for example. The tube 16 is dried by wind or heat for example.

The starch 12 is in the form of powder or grains made by grinding a plant. The plant can be wheat, potato, corn, yam, cassava, lotus root, rice, amorphophallus konjac or modified starch for example.

The diameter of each of the microcapsules 14 is 30 to 1000 μm. The microcapsules 14 are made by spray freezing, electrostatic bonding, porous centrifugation, oil and aqueous phase separation, double emulsion, spray-dried powder, interfacial polymerization, in-situ polymerization, and matrix polymerization for example.

At 20, the soaking is conducted. The tube 16 is soaked in wax 22. The wax 22 covers and infiltrates the tube 16. The wax 22 is edible. The wax 22 can be a natural product derived from an animal or plant such as beeswax. Alternatively, the wax 22 can be a mixture of natural wax (such as beeswax) with fatty acid.

At 30, the finishing is conducted. The wax 22 coated on the tube 16 is dried and trimmed for example. Thus, a straw 32 is made of the tube 16 and the wax 22. The straw 32 is edible because the tube 16 and the wax 22 are both edible.

The density (mass over volume) of the light and edible straw 32 is determined by the proportion of the starch 12 and the microcapsules 14. The density of the light and edible straw 32 is larger if the light and edible straw 32 includes more starch 12. The wall of the light and edible straw 32 is porous if the microcapsules 14 are empty. The wall of the light and edible straw 32 is solid if the microcapsules 14 are filled.

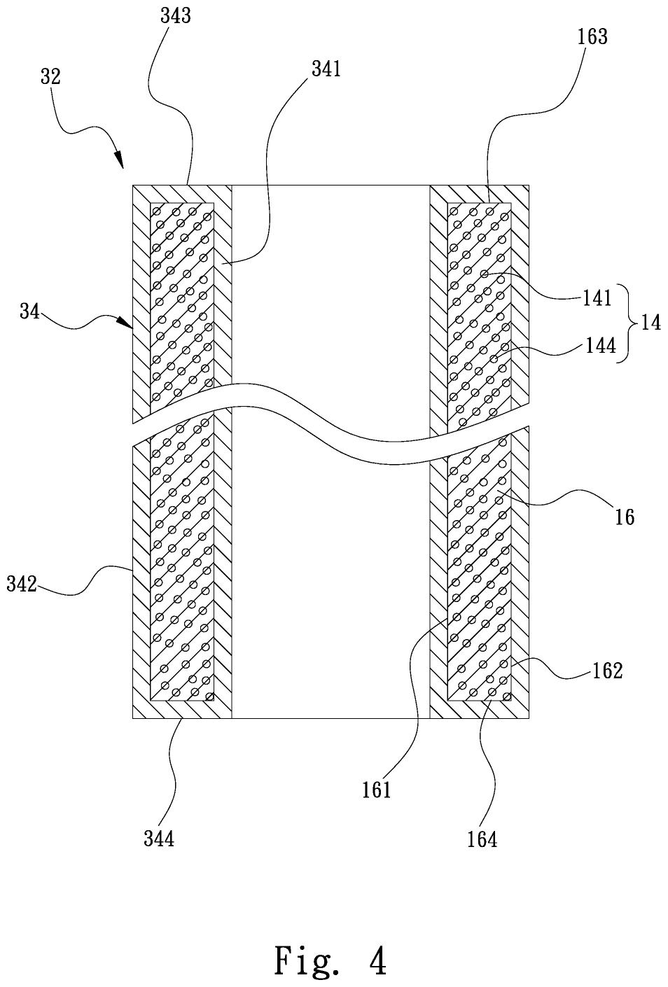

Referring to FIG. 4, the straw 32 includes a protective film 34 coated on the tube 16. The protective film 34 is made of the wax 22 when the wax 22 is dried. An internal portion 341 of the protective film 34 covers an internal face 161 of the tube 16. An external portion 342 of the protective film 34 covers the external face 162 of the tube 16. An upper annular portion 343 of the protective film 34 covers an end face 163 of the tube 16. A lower annular portion 344 of the protective film 34 covers the end face 164 of the tube 16. The protective film 34 keeps the tube 16 from liquid such as water or any proper drink. The weight of the light and edible straw 32 is substantially equal to the weight of the tube 16 plus the weight of the protective film 34. The wall of the tube 16 of the light and edible straw 32 includes empty microcapsules 141 and filled microcapsules 144.

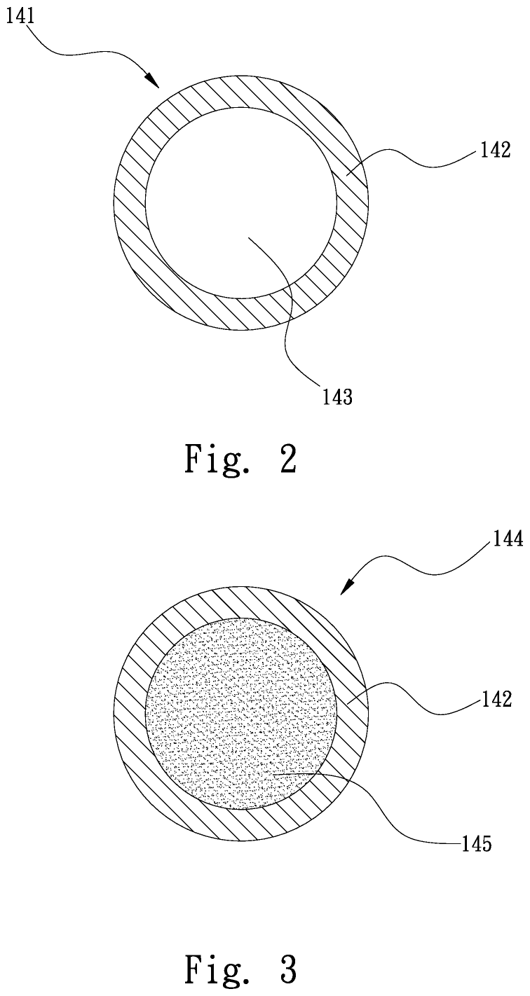

Referring to FIG. 2, each of the empty microcapsules 141 includes a wall 142 that encloses a space 143. The space 143 contains a type of gas such as air. The term, “empty”, means “filled with nothing but a type of gas” hereinafter. The density of the light and edible straw 32 is smaller if it contains more empty microcapsules 141. The empty microcapsules 141 render the light and edible straw 32 crunchy.

Referring to FIG. 3, each of the filled microcapsules 144 includes filling 145 filled in the space 143 enclosed by the wall 142. The filling 145 is solid or liquid such as butter, chocolate, strawberry jam, milk, a dairy product (such as fruit-flavored milk powder, ginger-flavored milk powder, coca-flavored milk powder and foam milk powder), sweetener (such as aspartame), seasoning (such as lemon oil, peppermint oil, garlic oil and curry oil). Thus, the filled microcapsules 144 flavor the light and edible straw 32.

Referring to FIG. 4, the end face 164 extends perpendicular to an axis of the tube 16. That is, the tube 161 includes a flat lower end.

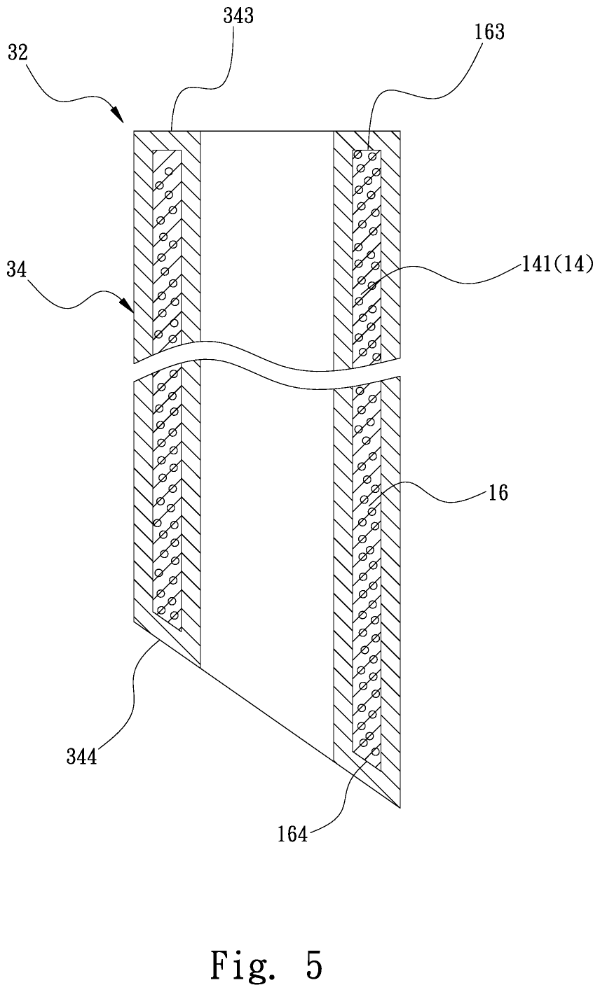

Referring to FIG. 5, the end face 164 does not extend perpendicular to the axis of the tube 16. That is, the tube 161 includes a pointed lower end.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A method for making a light and edible straw comprising the steps of:
mixing starch with microcapsules;
shaping the mixture into a tube;
drying the tube;
soaking the tube in wax so that the wax covers the tube.

2. The method for making a light and edible straw according to claim 1, wherein each of the microcapsules is made with a diameter of 30 to 1000 μm.

3. The method for making a light and edible straw according to claim 2, wherein the microcapsules comprise empty microcapsules each of which comprises a wall, a space enclosed in the wall, and a type of gas filled in the space.

4. The method for making a light and edible straw according to claim 3, wherein the type of gas is air.

5. The method for making a light and edible straw according to claim 2, wherein the microcapsules comprises filled microcapsules each of which comprises a wall, a space enclosed in the wall, and filling filled in the space.

6. The method for making a light and edible straw according to claim 5, wherein the filling is selected from the group consisting of butter, chocolate, strawberry jam, milk, flavored dairy products, sweeteners and seasoning.

7. The method for making a light and edible straw according to claim 1, wherein the wax is edible wax coated on the tube.

8. The method for making a light and edible straw according to claim 7, wherein the edible wax is a natural product derived from the group consisting of an animal and a plant.

9. The method for making a light and edible straw according to claim 7, wherein the edible wax is a synthetic product made by mixing natural wax with fatty acid.

10. A light and edible straw comprising:
a tube made of an edible material and comprising an internal face, an external face, an upper end face and a lower end face;
microcapsules made of another edible material and inserted in a wall of the tube; and
a protective film made of another edible material and comprising an internal portion covering the internal face of the tube, an external portion covering the external face of the tube, an upper annular portion covering the upper end face of the tube and a lower annular portion covering the lower end face of the tube, thereby keeping the tube from liquid.

11. The light and edible straw according to claim 10, wherein at least some of the microcapsules is filled with a type of gas.

12. The light and edible straw according to claim 10, wherein at least some of the microcapsules is filled with filling.

13. The method for making a light and edible straw according to claim 12, wherein the filling is selected from the group consisting of butter, chocolate, strawberry jam, milk, flavored dairy products, sweeteners and seasoning.
